(19) United States
(12) Patent Application Publication
(10) Pub. No.: US 2023/0320260 A1
(43) Pub. Date: Oct. 12, 2023

(54) AUTOMATIC FERTILIZING APPARATUS

(71) Applicant: Kenneth L Moody, Moreno Valley, CA (US)

(72) Inventor: Kenneth L Moody, Moreno Valley, CA (US)

(21) Appl. No.: 17/717,877

(22) Filed: Apr. 11, 2022

(51) Int. Cl. A01C 23/04; A01G 25/02; A01G 25/16; A01C 23/00

(52) U.S. Cl. CPC A01C 23/042; A01G 25/023; A01G 25/165; A01C 23/007

(57) ABSTRACT

An automatic fertilizing apparatus connected in series with a sprinkle watering system. The apparatus includes a liquid fertilizer container having an inlet and an outlet, and a venturi tube configured to sealably fit into the inlet and outlet of the container. The fertilizing apparatus includes a venturi tube that can sealably fit into the inlet port and the outlet port. Water pumped into the venturi tube can produce a partial vacuum that allows the liquid fertilizer in the container to be drawn into the venturi tube through a slot in the venturi tube. The liquid fertilizer can mix with the water stream in the venturi tube and the mixture of water and liquid fertilizer can be dispensed through a sprinkler head of the sprinkle watering system.

### TECHNICAL FIELD

The present invention relates to a fertilizing apparatus, and more particularly, the present invention relates to a liquid fertilizer apparatus for use with a water sprinkler system.

### BACKGROUND

Water sprinkle system has become quite common in lawns, parks, fields, and like for watering the plants, lawns, and crops. Water sprinkle systems are generally used in commercial and residential places for watering lawns and plants. The water sprinkle systems have several advantages, such as watering the lawn and plants can be automated and wastage of water is very less.

Besides, watering, the fertilizers must also be periodically applied to lawns, plants, and crops. In the case of crops, fertilizers are frequently used, specifically in the fast-growing phase of the crop. There are many methods known in the art for the application of fertilizers.

However, a desire is always there for an improved method and apparatus that is economic, efficient, and easy to use.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a liquid fertilizing apparatus that can be incorporated into a water sprinkler system.

It is another object of the present invention that the liquid fertilizing apparatus can be retrofitted into an existing water sprinkler system.

It is still another object of the present invention that the liquid fertilizing apparatus is economic to manufacture.

It is yet another object of the present invention that the rate of fertilizer application can be controlled.

It is a further object of the present invention that the liquid fertilizing apparatus allows a selectable quantity of the liquid fertilizer to be automatically sprayed in commercial or residential lawns and gardens.

It is still a further object of the present invention that the liquid fertilizer apparatus can also be used to apply insecticides or herbicides.

It is an additional object of the present invention that the liquid fertilizing apparatus is easy and economical to maintain.

In one aspect, disclosed is a liquid fertilizer apparatus that can function in combination with an existing water sprinkler system. The liquid fertilizer apparatus can include a container for holding the liquid fertilizer, the container has a base and a wall that upstands from a periphery of the base, wherein the base and the wall define an inner volume of the container. The top of the container can be open and cover by a cap. The wall of the container can have an inlet and an outlet, wherein a venturi tube can sealably bridge between the inlet and the outlet of the container. The supply line connecting the water source to the water sprinklers can be connected in series with a water control valve, the venturi tube, and at least one sprinkler head. The venturi tube can have one or more slots, wherein water passing through the venturi tubes undergo a change in pressure resulting in the formation of a partial vacuum. The partial vacuum through one or more slots of the venturi tube can draw liquid fertilizer from the container into the venturi tube, wherein the liquid fertilizer can mix with the water, and the mixture of the liquid fertilizer in the water can be dispensed through sprinklers.

In one aspect, the liquid fertilizing apparatus can be installed between an output of a water source and an input of one or more sprinkler heads. Preferably, the liquid fertilizing apparatus can be installed between an output of the water control valve and the input of at least one sprinkler head. When a stream of water flows through the venturi tube, the water due to change in pressure results in a partial vacuum within the venturi tube that functions as an aspirator. The negative pressure or partial vacuum causes the liquid fertilizer in the fertilizer container to be drawn through one or more slots and into the flowing stream of water.

To further enhance the design of the liquid fertilizing apparatus, an inlet end of the venturi tube can be attached to an inlet locknut, a one-way control valve, and a rotating union that can be attached to the supply line connected to the water source. Likewise, an outlet end of the venturi tube i.e., the flared end can be connected to an outlet locknut and a sprinkler tube adapter for connecting to the supply line connecting the sprinklers.

In one aspect, the liquid fertilizer can be any liquid fertilizer, natural or synthetic, known to a skilled person for use in lawns, plants, and crops, and includes solid fertilizers dissolved in water.

These and other objects and advantages of the present invention will become apparent from the subsequent detailed description of the preferred embodiment and the appended claims taken in conjunction with the accompanying drawings.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram of a liquid fertilizing apparatus incorporated into a typical water sprinkler system, according to an exemplary embodiment of the present invention.

FIG. 2 is an exploded view of the liquid fertilizing apparatus, according to an exemplary embodiment of the present invention.

### DETAIL DESCRIPTION

hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

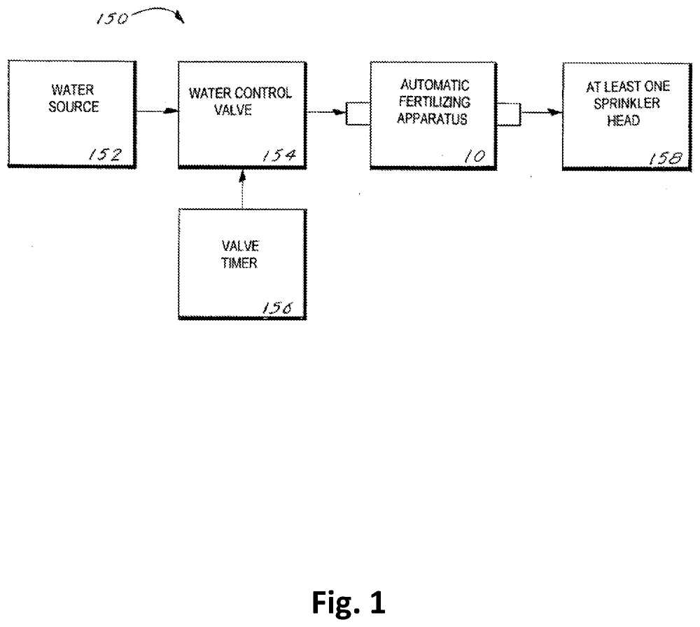

Disclosed is a liquid fertilizing apparatus that can be used in combination with a typical water sprinkler system for the application of liquid fertilizer in a lawn, plants, or crops. The liquid fertilizing apparatus can be installed in series and to function in combination with an existing watering system, wherein a quantity of liquid fertilizer can be infused into a flowing stream of water. A typical watering system 150, as shown in FIG. 1, can include a water source 152 such as a utility water source, a water control valve 154 that can be operated manually or automatically by an electrically operated valve timer 156, and at least one sprinkler head 158. As also shown in FIG. 1, the liquid fertilizing apparatus 10 can be installed between an output of the water control valve 154 and an input of at least one sprinkler head 158.

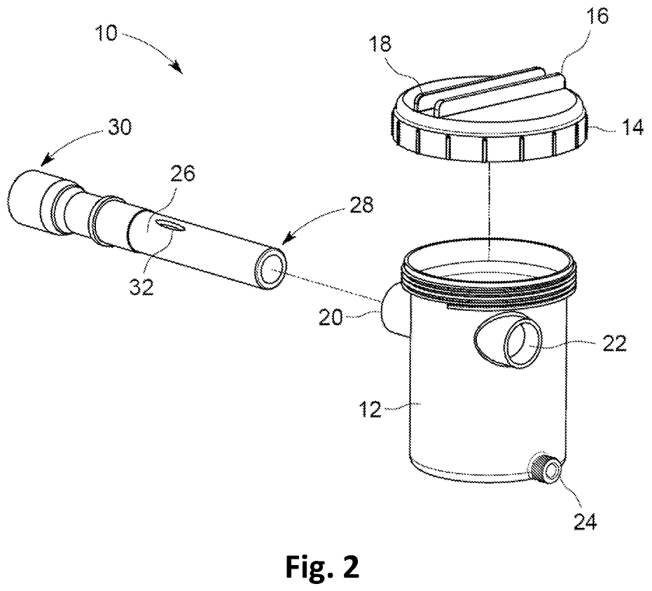

Referring to FIG. 2, the liquid fertilizing apparatus 10 can include a container 12 which is cylindrical having a base and a wall that extends from a periphery of the base, wherein the base and the wall defines an inner volume of the container. Preferably, the container can be cylindrical that allows handle more pressure than a cuboidal shape container. For example, the cylindrical container, also referred herein as the canister can easily handle 90 psi of pressure.

The top of container 12 can be open, and a cap can be used to cover the open top of the container. FIG. 2 shows a round cap 14 covering the open top of the container 12. The cap can be screwed to the container, wherein the container and the cap can be provided with mating threads that allow the cap to be screwed to the container. The cap can be made from a sturdy material, such as high-density plastic that prevents the cap from exploding. The top of the cap can include an integral first upward-extending protrusion 16 and that is in alignment with a second upward-extending protrusion 18. The two protrusions allow the cap 14 to be easily grasped when removing or attaching the cap. The two protrusions also allow the shaft of a screwdriver to be angularly placed across the two protrusions 16,18. The shaft allows additional torque to be applied to loosen container caps that require additional force to open.

Container 12 can have an inlet 20 and an outlet 22 made in the wall of the container. The inlet 20 and outlet 22 can be in a form of bosses that provides fluid communication between an inner volume of container 12 and the outside. The inlet 20 and outlet 22 can be on opposite sides, such as a common axis that can pass through the centers of inlet 20 and outlet 22.

On the bottom side of the container, 12 can be seen a nozzle 24 that may be fluidly connected to a large vat, that may contain the liquid fertilizer. The nozzle 24 shown in FIG. 2 is having threads that allow coupling the vat through a threaded connection of a hose.

FIG. 2 also shows an elongated venturi tube 26 having a narrow end 28 and a flared end 30. The venturi tube 26 can be inserted into the inlet 20 of container 12 and protrudes from outlet 22, such as the venturi tube 26 can be fit into the bosses of the container, i.e., the inlet 20 and outlet 22. The flared end 30 of the venturi tube 26 can be retained at the inlet 20 and can attach to the water source or the water control valve. The other end of the venturi tube 26 can be connected to the supply line of the sprinkler head. Water while passing through the venturi tube 26 changes in pressure which can create a partial vacuum. The partial vacuum causes the liquid fertilizer in container 12 to be drawn into the venturi tube 26. The amount of liquid fertilizer received into the venturi tube 26 can depend on the amount of the partial vacuum, which can be controlled. The venturi tube 26 can have a protrusion 32 through which the liquid fertilizer from the container can be drawn into the venturi tube 26, wherein the liquid fertilizer can be mixed up with the stream of water passing through the venturi tube 26. The liquid fertilizer can be carried by the water, for example as a solution, through the supply line into the sprinkler heads, wherein the mixture of liquid fertilizer in water can be sprayed by the sprinkler heads in the field.

The flared end can be connected to the supply line that connects to the water source or the water control valve. The water control valve can control the amount of water that enters the venturi tube 26. Similarly, the narrow end of the venturi tube 26 can be connected to the supply line connecting the sprinkler heads. Fasteners, such as locknut and sprinkler tube adapter can be used to connect the narrow end of the venturi tube 26 to the supply line of the sprinkler head. The flared end can also be connected to the supply line using fasteners, such as locknuts. Additionally, a fertilizer metering control knob and a backflow control valve can also be used to control the flow of water, and thus controlling the amount of partial vacuum created in the venturi tube 26, and thus the amount of liquid fertilizer drawn into the venturi tube 26. The venturi tube 26 can be sealably fit into the inlet 20 and outlet 22. Embodiments of the “U.S. Pat. No. 7,395,978B2” including units connected in parallel are within the scope of the present invention. Fasteners explained in “U.S. Pat. No. 7,395,978B2” such as rotating union can be used to connect the disclosed apparatus to the supply lines and connecting the disclosed apparatuses as units in parallel to a water inlet manifold. Shut-off valves described in “U.S. Pat. No. 7,395,978B2” can also be used to allow each fertilizer container 12 to be individually operated.

While the invention has been described in complete detail and pictorially shown in the accompanying drawings it is not to be limited to such details, since many changes and modifications may be made to the invention without departing from the spirit and the scope thereof. For example, the disclosed apparatus can be designed to be placed underground or above ground and can be color-coded to indicate the liquid capacity of the fertilizer container, and can include a transparent window on container 12 to show the quantity of fertilizer remaining in container 12. Hence, it is described to cover any and all modifications and forms, which may come within the language and scope of the claims.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An automatic fertilizing apparatus that functions in combination with a sprinkler watering system having a water source connected in series with a water control valve and at least one sprinkler head, wherein said automatic fertilizing apparatus can be installed by interrupting a supply line connecting the water source or the water control valve to the at least one sprinkler head, the automatic fertilizing apparatus comprises:
a container having a base, a wall that upstands from a periphery of the base, and an open-top, the container has an inlet and an outlet, wherein the inlet and the outlet are aligned along a common central axis that passes through a center of the inlet and the outlet;
a cap threadedly coupled to the open-top for closing it; and
a venturi tube that has a narrow end and a flared end, wherein the narrow end is configured to be inserted through the inlet and into the outlet, wherein the venturi tube configured to be sealably fit into the inlet and the outlet, the narrow end configured to connect to a first supply line connecting the water source, and the flared end configured to connect to a second supply line connecting the sprinkler head,
wherein the venturi tube is configured such as water passing through the venturi tube undergoes a change in pressure resulting in a formation of a partial vacuum, wherein the partial vacuum draws liquid fertilizer from the container into the venturi tube.

2. The automatic fertilizing apparatus according to claim 1, wherein the venturi tube comprises an elongated aperture through which the liquid fertilizer is drawn.

3. The automatic fertilizing apparatus according to claim 1, wherein the automatic fertilizing apparatus further comprises a water control value in fluid communication with the inlet, the water control valve operably coupled to an electrically operated valve timer.

4. The automatic fertilizing apparatus according to claim 1, wherein the container is cylindrical.

5. The automatic fertilizing apparatus according to claim 1, wherein the cap further comprises a first integral upward-extending protrusion and a second integral upward-extending protrusion, wherein the first integral upward-extending protrusion and the second integral upward-extending protrusion are spaced apart from each other and are parallel to each other.

6. The automatic fertilizing apparatus according to claim 4, wherein the container further comprises a nozzle near a bottom of the container, wherein the nozzle is configured to fluidly connect an inner volume of the container to a vat.

7. The automatic fertilizing apparatus according to claim 4, wherein the automatic fertilizing apparatus further comprises a locknut and a sprinkler tube adapter configured to couple the outlet to the second supply line connecting the sprinkler head.

8. The automatic fertilizing apparatus according to claim 1, wherein the automatic fertilizing apparatus further comprises a fertilizer metering control knob fluidly coupled to the inlet and configured to control the partial vacuum created in the venturi tube.

9. A method for applying fertilizers, the method comprising the steps of:
providing an automatic fertilizing apparatus configured to be installed in a sprinkler watering system, the sprinkler watering system comprises a water source connected in series with a water control valve and at least one sprinkler head, wherein said automatic fertilizing apparatus can be installed by interrupting a supply line connecting the water source or the water control valve to the at least one sprinkler head, the automatic fertilizing apparatus comprises:
a container having a base, a wall that upstands from a periphery of the base, and an open-top, the container has an inlet and an outlet, wherein the inlet and the outlet are aligned along a common central axis that passes through a center of the inlet and the outlet,
a cap threadedly coupled to the open-top for closing it, and
a venturi tube that has a narrow end and a flared end, wherein the narrow end is configured to be inserted through the inlet and into the outlet, wherein the venturi tube configured to be sealably fit into the inlet and the outlet, the narrow end configured to connect to a first supply line connecting the water source, and the flared end configured to connect to a second supply line connecting the sprinkler head,
wherein the venturi tube is configured such as water passing through the venturi tube undergoes a change in pressure resulting in a formation of a partial vacuum, wherein the partial vacuum draws liquid fertilizer from the container into the venturi tube.

10. The method according to claim 9, wherein the venturi tube comprises an elongated aperture through which the liquid fertilizer is drawn.

11. The method according to claim 9, wherein the automatic fertilizing apparatus further comprises a water control value in fluid communication with the inlet, the water control valve operably coupled to a an electrically operated valve timer.

12. The method according to claim 9, wherein the container is cylindrical.

13. The method according to claim 9, wherein the cap further comprises a first integral upward-extending protrusion and a second integral upward-extending protrusion, wherein the first integral upward-extending protrusion and the second integral upward-extending protrusion are spaced apart from each other and are parallel to each other.

14. The method according to claim 12, wherein the container further comprises a nozzle near a bottom of the container, wherein the nozzle is configured to fluidly connect an inner volume of the container to a vat.

15. The method according to claim 9, wherein the automatic fertilizing apparatus further comprises a locknut and sprinkler tube adapter configured to couple the outlet to the second supply line connecting the sprinkler head.

16. The method according to claim 9, wherein the automatic fertilizing apparatus further comprises a fertilizer metering control knob fluidly coupled to the inlet and configured to control the partial vacuum created in the venturi tube.
